(19) United States
(12) Patent Application Publication
(10) Pub. No.: US 2016/0282542 A1
(43) Pub. Date: Sep. 29, 2016

(54) DUAL VIEWING FILM AND DUAL VIEW DISPLAY APPARATUS USING THE SAME

(71) Applicant: 3M INNOVATIVE PROPERTIES COMPANY, St. Paul, MN (US)

(72) Inventors: Jeong-Yeon SEO, Gyeonggi-do (KR); Byoung-Kyu KIM, Busan-City (KR); Soo-Jin JANG, Gyeonggi-do (KR)

(21) Appl. No.: 15/037,275

(22) PCT Filed: Nov. 19, 2014
(86) PCT No.: PCT/US2014/066279

§ 371 Date: May 17, 2016

(30) Foreign Application Priority Data
Nov. 19, 2013 (KR) 10-2013-0140530

(51) Int. Cl. F21V 8/00; G02B 3/00; G02B 27/22; G02B 5/04

(52) U.S. Cl. CPC G02B 6/0053; G02B 5/045; G02B 3/0037; G02B 6/0076; G02B 27/225

(57) ABSTRACT

Disclosed are a dual viewing film and a dual view display apparatus using the same, and the dual view display apparatus includes left and right edge emitting light sources (for example, LED light sources), a dual viewing film having a prism pattern and a lens shape at a lower surface of a substrate; a structured light guide plate, and a display panel (for example, an LCD panel) having a high refresh rate, thereby displaying different images, of which resolution is not reduced, to viewers in left and right directions.

### TECHNICAL FIELD

The present disclosure relates to a dual viewing film and a dual view display apparatus using the same, and more particularly, to a dual viewing film, which includes a prism input layer and a lens output layer to refract light so as to head toward a viewer in a left or right direction deviating from a normal axis of a dual view display, and a dual view display apparatus using the same.

### BACKGROUND

A display system is mounted in a car for the various purposes, such as a navigation map, a rear viewing camera display, a car control display, a web-browsing display, and a broadcasting display.

The car navigation display is widely adopted in vehicles for various purposes, such as a simple car navigation function for guiding a driver to a proper destination by using a specific path, a function of showing a driver whether there is an object or obstacle when moving backward, and a function of sharing various different content (movie, TV content, and the like).

However, too much information other than navigation may distract the driver. This may result in serious car accidents. In order to prevent a driver from viewing various contents while driving, a dual image display is suitable for both driver and a front passenger. The driver may view navigation content only, while the front passengers may view desired content. That is, the dual image display of the car navigation displays a navigation image to the driver, but displays different content to the front passengers.

A typical dual image display is implemented with a parallax barrier display in order to divide an image into a left image and a right image. The technique is widely adopted in most of the cars in several markets. FIGS. 1 and 2 are explanatory diagrams for a dual image display mounted in a car in the prior art.

A typical example of a parallax barrier function, such as an image division, is illustrated in FIGS. 1 and 2.

As illustrated in FIG. 1, the dual image display in the prior art includes a screen 110 and a parallax barrier 120. The parallax barrier 120 includes a barrier for intentionally dividing an image to a left image 111 and a right image 112 of the screen 110. Light from the screen 110 from an LCD panel is individually split by the parallax barrier 120 to reach a left side 101 and a right side 102.

Alternatively, as illustrated in FIG. 2, the dual image display in the prior art includes a screen 110 and a convex lens 220. The convex lens 220 includes a lens refracting a left image 212 and a right image 211 of the screen 110. The light from the screen 110 is individually refracted by the convex lens 220 to reach a left side 201 and a right side 202.

The technique illustrated in FIGS. 1 and 2 shows one view corresponding to each position in left and right viewing zones. Accordingly, a viewer experiences parallax motion and binocular stereo without the use of special glasses. The drawback of this type of display is a decrease in resolution by half because an LCD panel displays the two left and right images interlaced line by line.

FIG. 3 is an example diagram of left and right views by the parallax barrier display in the prior art.

The dual view display in the prior art adopts a spatial multiplexing method using a parallax barrier 320 or a lens-shaped lens or prism lens. The spatial multiplexing method decreases resolution of an original image 310 by half. The reason is that the original image 310 is spatially divided in order to implement the dual view display. This is one of the drawbacks which cannot be solved with the parallax barrier method even though the dual view display of the spatial multiplexing is adopted technically and easily.

FIG. 4 is an example diagram for an image viewed by left, center, and right viewers through the dual view display adopting the parallax barrier method in the prior art.

The dual view display adopting the parallax barrier method in the prior art alternately displays the whole left image L and right image R to left users 401, center user 403, and right users 402.

### SUMMARY

The present invention solves an issue from a parallax barrier and a lenticular type dual image display. The present invention solves the problem of a decrease in resolution of an image by using a field sequential bidirectional backlight with a high refresh rate panel combination.

The present invention provides a dual viewing film, and a dual view display apparatus using the same, which includes left and right edge emitting light sources (for example, LED light sources), a structured light guide plate, dual viewing film having a prism pattern and a lens shape at a lower surface of a substrate, and a display panel (for example, an LCD panel) having a high refresh rate, thereby displaying different images, of which resolution is not reduced, to viewers in left and right directions. 3D Display utilizes high refresh rate LCD panel to realize 3D effect and its typical refresh rate is 120 HZ, 240 HZ which most of shutter glasses 3D LCD TV use. This invention doesn't necessarily require such high refresh rate because it is not 3D display and less than 120 HZ over 90 HZ refresh rate panel is sufficient.

The present invention minimizes crosstalk through a dual viewing film having a peak-to-peak deviation between a prism pitch of a prism input layer and a lens pitch of a lens output layer in a case where the crosstalk is generated in a dual view display apparatus.

The present invention provides a dual view display apparatus having a symmetric light output distribution by using light sources having different luminance in a case where an asymmetric light output distribution is generated by a dual viewing film having a pitch deviation.

The present invention provides a dual view display apparatus having a symmetric light output distribution by using a dual light guide plate formed of first and second light guide plates even though light sources having the same luminance intensities are used in a case where luminance intensity of left and right light sources is not adjusted.

An exemplary embodiment of the present disclosure provides a dual viewing film in a dual view display, including: a substrate layer; a prism input layer formed on a lower surface of the substrate layer and provided with a plurality of prisms having a prism apex angle and a prism pitch; and a lens output layer formed on an upper surface of the substrate layer and provided with a plurality of lens having a lens pitch and a lens curvature radius, wherein light input in a left side or a right side of the prism input layer is reflected, and the reflected light is refracted so as to head toward a viewer in a left or right direction deviating from a normal axis of the dual view display through the lens output layer.

The light refracted from the lens output layer may head toward the viewer in the right or left direction deviating by ±10° or more from the normal axis of the dual view display. The prism input layer may be provided with the plurality of prisms having the prism apex from 80° to 90°, and the prism pitch from 40 um to 60 um.

Peak centers of the prism pitch of the prism input layer and the lens pitch of the lens output layer may be misaligned so that crosstalk of the dual view display is decreased to a value equal to or lower than a predetermined value.

A peak-to-peak pitch value between the prism pitch of the prism input layer and the lens pitch of the lens output layer may be misaligned within a range from 0 um to 20 um.

Another exemplary embodiment of the present disclosure provides a dual view display apparatus using a dual viewing film, comprising: a light guide plate configured to guide a path of an output light; left and right light sources configured to be adjacent to the light guide at the both edge of the light guide to guide a path of the output light and output light in a left direction or a right direction according to continuous left and right timings; a reflection surface configured to on bottom of the light guide to reflect back the light from the light guide and reflect back the output light; a dual viewing film including a prism input layer, on which a plurality of prisms is continuous across the entire lower surface thereof, and a lens output layer, on which a plurality of lens is continuous across entire upper surface thereof, configured to on top of the light guide to direct light from both light sources and reflect light input in a left side or a right side of the prism input layer from the light guide plate, and refract the reflected light so as to head toward a viewer in a left or right direction deviating from a normal axis of the dual view display through the lens output layer; and a display panel configured to on top of dual viewing film and display different images to the viewer in the left or right direction by using the refracted light.

The prism input layer may have a pattern perpendicular to light emission directions of the left and right light sources at a lower surface of the dual viewing film, and the lens output layer may have a pattern perpendicular to the light emission directions of the left and right light sources at an upper surface of the dual viewing film.

A pitch deviation exists between the prism input layer and the lens output layer of the dual viewing film, and the left and right light sources may output light with different luminance intensities to the left direction and the right direction, respectively, so as to have an asymmetric light distribution.

The light guide plate may include first and second light guide plates positioned in a horizontal direction, the first and second light guide plates may be combined with the left and right light sources, respectively, and paths of the light output from the left and right light sources may be guided through the combined first and second light guide plates, respectively.

The first light guide plate and the second light guide plate are positioned at an upper surface and a lower surface of the combined light guide plate, respectively, such that an air gap may be formed between the upper surface of the second light guide plate and the lower surface of the first light guide plate.

The display panel may display different images to the viewer in the left or right direction through a liquid crystal display by reproducing the different images with at a 90 HZ refresh rate or more.

An edge surface of the light guide plate may be pattern treated to minimize crosstalk generated from light reflected back by the reflection surface.

The light refracted from the lens output layer may head toward the viewer in the right or left direction deviating by ±10° or more from the normal axis of the dual view display.

The prism input layer may be provided with the plurality of prisms having the prism apex from 80° to 90°, and the prism pitch from 40 um to 60 um.

Peak centers of the prism pitch of the prism input layer and the lens pitch of the lens output layer may be misaligned so that crosstalk of the dual view display is decreased to a value equal to or lower than a predetermined value.

A peak-to-peak pitch value between the prism pitch of the prism input layer and the lens pitch of the lens output layer may be misaligned within a range from 0 um to 20 um.

According to the exemplary embodiments of the present disclosure, it is possible to solve a decrease in resolution of an image by using a field sequential bidirectional backlight having a high refresh rate panel combination.

The exemplary embodiments of the present disclosure include left and right edge emitting light sources (for example, LED light sources), a structured light guide plate, a dual view film having a prism pattern and a lens shape at a lower surface of a substrate, and a display panel (for example, an LCD panel) having a high refresh rate, so that it is possible to display different images, of which resolution is not reduced, to viewers in left and right directions.

According to the exemplary embodiments of the present disclosure, it is possible to minimize crosstalk through the dual viewing film having the peak-to-peak deviation between a prism pitch of the prism input layer and a lens pitch of the lens output layer in a case where the crosstalk is generated in the dual view display apparatus.

According to the exemplary embodiments of the present disclosure, in a case where an asymmetric light output distribution is generated by a dual viewing film having a pitch deviation, it is possible to provide a symmetric light output distribution by using light sources having different luminance

According to the exemplary embodiments of the present disclosure, in a case where luminance intensities of left and right light sources are not adjusted, it is possible to provide a symmetric light output distribution by using the dual light guide plate formed of the first and second light guide plates even though light sources having the same luminance intensities are used.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIGS. 1 and 2 are explanatory diagrams for a dual image display mounted in a car in the prior art.

FIG. 3 is an example diagram of left and right views by a parallax barrier display in the prior art.

FIG. 4 is an explanatory diagram for an image viewed by left, center, and right viewers through the dual view display adopting the parallax barrier method in the prior art.

FIGS. 5A and 5B are concept diagrams for a dual view display apparatus using left and right edge emission according to an exemplary embodiment of the present disclosure.

FIG. 6 is an explanatory diagram for a control timing of an LCD panel and a backlight for driving a dual view display according to the exemplary embodiment of the present disclosure.

FIGS. 7A, 7B and 7C are explanatory diagrams of a structure and a light output angle of a dual viewing film according to an exemplary embodiment of the present disclosure.

FIGS. 8A, 8B, 8C, 8D, 8E and 8F are conoscope explanatory diagrams for an angular light distribution in various display structures.

FIG. 9 is an example diagram of left and right views in a dual view display to which the dual viewing film according to the exemplary embodiment of the present disclosure is applied.

FIGS. 10 and 11 are an explanatory diagram of images viewed by left viewers, a center viewer, and right viewers through a dual view display adopting temporal multiplexing according to the exemplary embodiment of the present disclosure, and an example diagram of the images.

FIGS. 12 and 13 are explanatory diagrams for an output angle simulation by a prism apex angle and an input angle and an output angle calculation process according to the exemplary embodiment of the present disclosure.

FIGS. 14A, 14B, 14C and 14D are explanatory diagrams for crosstalk according to a peak deviation between a prism input layer and a lens output layer according to the exemplary embodiment of the present disclosure.

FIG. 15 is an explanatory diagram for a viewing angle distribution simulation according to a peak deviation between the prism input layer and the lens output layer according to the exemplary embodiment of the present disclosure.

FIG. 16 is an explanatory diagram for an optical simulation result according to a prism angle and a peak-to-peak deviation according to the exemplary embodiment of the present disclosure.

FIGS. 17A and 17B are explanatory diagrams of first and second crosstalk generated in the dual viewing film of the present disclosure.

FIG. 18 is a configuration diagram for a dual view display apparatus using the dual viewing film according to the exemplary embodiment of the present disclosure.

FIG. 19 is an explanatory diagram for an optical simulation result of a light output distribution using a light guide plate with dual side LEDs applied to the present disclosure.

FIGS. 20 and 21 are explanatory diagrams for an optical simulation result using two types of dual viewing films according to the exemplary embodiment of the present disclosure.

FIGS. 22 and 23 are explanatory diagrams for a light output distribution of the dual view display apparatus using light sources having different luminance intensities according to the exemplary embodiment of the present disclosure.

FIG. 24 is a configuration diagram of a dual view display apparatus using a dual light guide plate according to the exemplary embodiment of the present disclosure.

FIG. 25 is an explanatory diagram for an asymmetric optical simulation result of the dual light guide plate combined with the same light sources according to the exemplary embodiment of the present disclosure.

FIG. 26 is an explanatory diagram for an optical simulation result for the dual view display apparatus using the dual light guide plate according to the exemplary embodiment of the present disclosure.

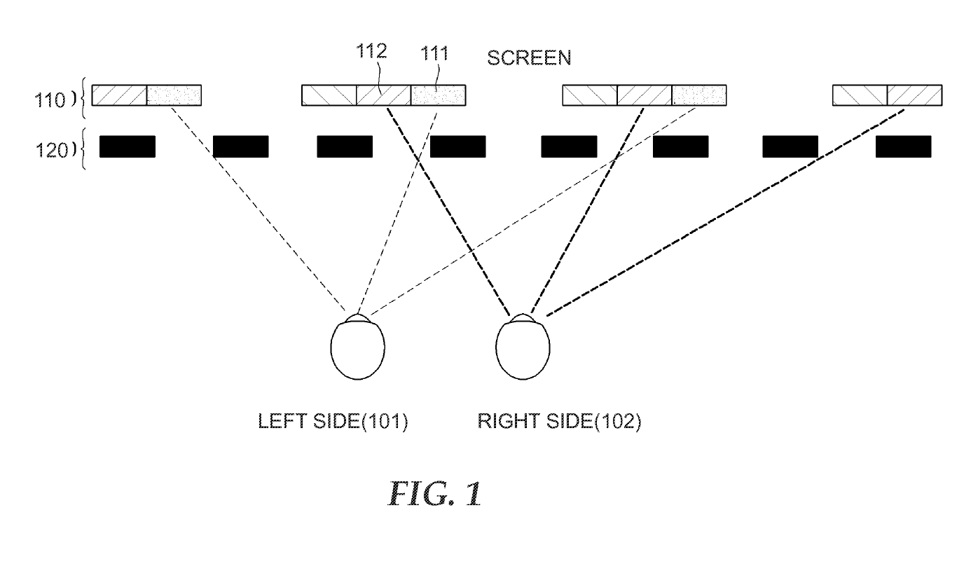

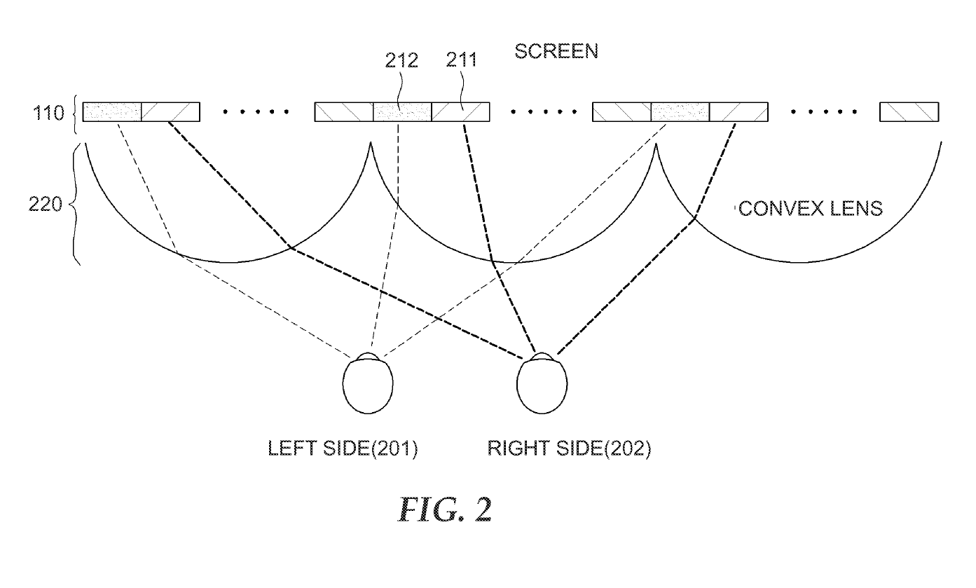

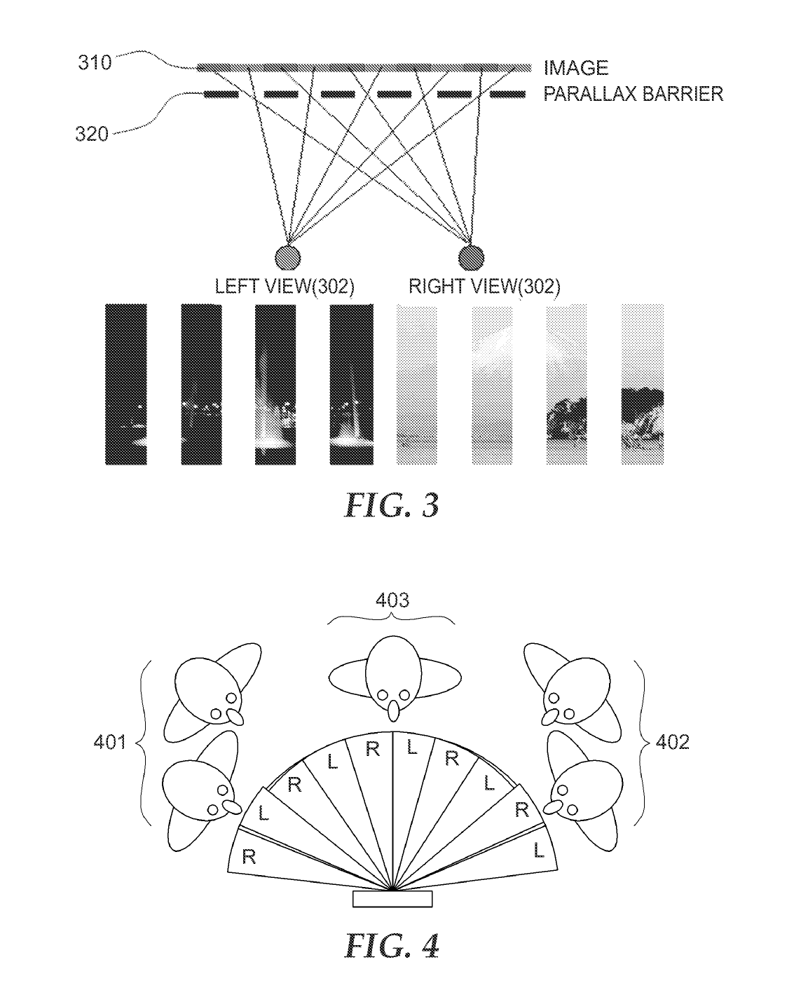

### DETAILED DESCRIPTION

In the following detailed description, reference is made to the accompanying drawing, which forms a part hereof. The illustrative embodiments described in the detailed description, drawing, and examples are not meant to be limiting. Other embodiments may be utilized, and other changes may be made, without departing from the spirit or scope of the subject matter presented here.

Hereinafter, exemplary embodiments according to the present disclosure will be described in detail with reference to the accompanying drawings. A configuration of the present disclosure and a resultant operational effect will be clearly understood through the detailed description below. In the following description, the same elements will be designated by the same reference numerals although the elements are illustrated in different drawings, and a detailed explanation of known prior constitutions may be omitted so as to avoid unnecessarily obscuring the subject matter of the present disclosure.

A dual image display according to the exemplary embodiments of the present disclosure provides a dual image display in a car without sacrificing resolution which is typical in a dual image display adopting a parallax barrier method.

A 3D film provides an autostereoscopic image by turning light emitted from an edge emitting LED toward each eye of a viewer. Differently from this, the dual image display according to the exemplary embodiments of the present disclosure can generate evenly distributed light suitable for the dual image display by a prism geometry of a film. The dual image display may be very usefully applied to a car navigation display installed in a vehicle.

A car navigation display in the prior art provides one image to both a driver and a passenger. However, in the exemplary embodiments of the present disclosure, it is possible to provide different images to a driver and a passenger without resolution reduction. For example, a driver watches a navigation map. However, a passenger watches other content, such as a movie, web browsing, or traffic information.

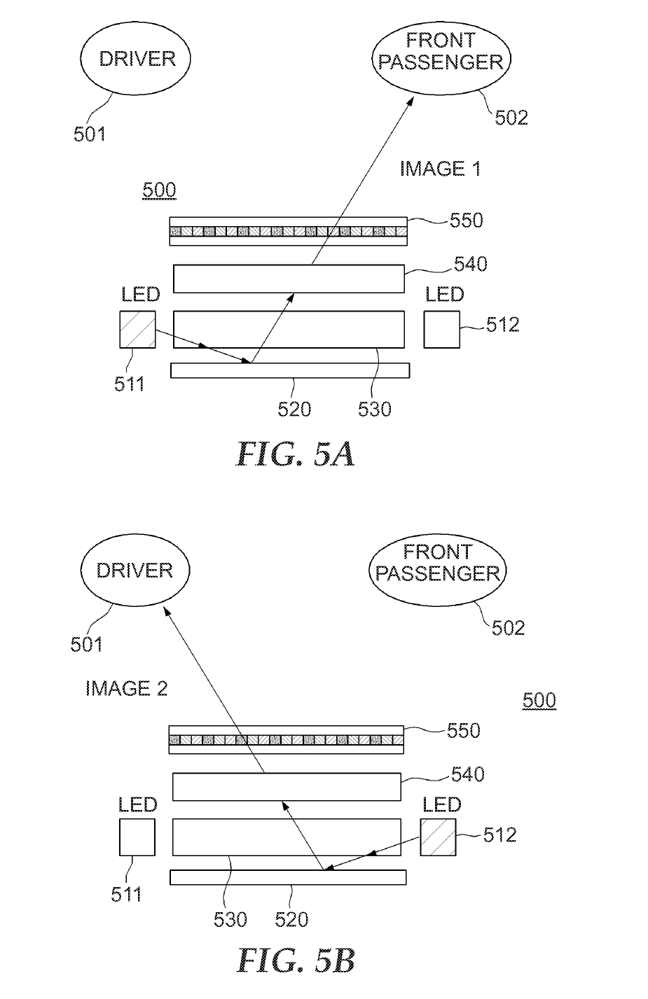

FIGS. 5A and 5B are concept diagrams of a dual view display apparatus using left and right edge emission according to the exemplary embodiment of the present disclosure.

As illustrated in FIGS. 5A and 5B, a dual view display 500 includes left and right edge emitting LEDs 511 and 512, a reflection surface 520, a light guide plate 530 having a pattern, a dual viewing film 540, and a display panel 550.

Here, the dual viewing film 540 has a lenticular structure on an upper surface thereof and a prismatic structure in a lower surface thereof. The display panel 550 is formed of a liquid crystal display (LCD) panel having a high refresh rate.

A structure in which a front passenger 502 may view image 1 is illustrated in FIG. 5A.

The left LED light source 511 is turned on, and light from the left LED light source 511 is injected in the light guide plate 530. The light injected into the light guide plate 530 is refracted or is reflected back to a reflection surface 520 formed, for example, of an enhanced specular reflector (ESR) Enhanced Specular Reflector is one of Specular Reflector and Silver Deposited on PET Film reflector can also be used but it is less efficient than ESR.

In this case, the dual viewing film 540 redirects some of the light reflected back to the reflection surface 520 and the light from the light guide plate 530 toward the front passenger 502 in the car. Before the right LED light source 512 is turned on, the left image is uploaded to the display panel 550 with full resolution.

Then, the right LED light source 512 is turned on, and the driver 501 may view another image 2 through the light injected from the right LED light source 512.

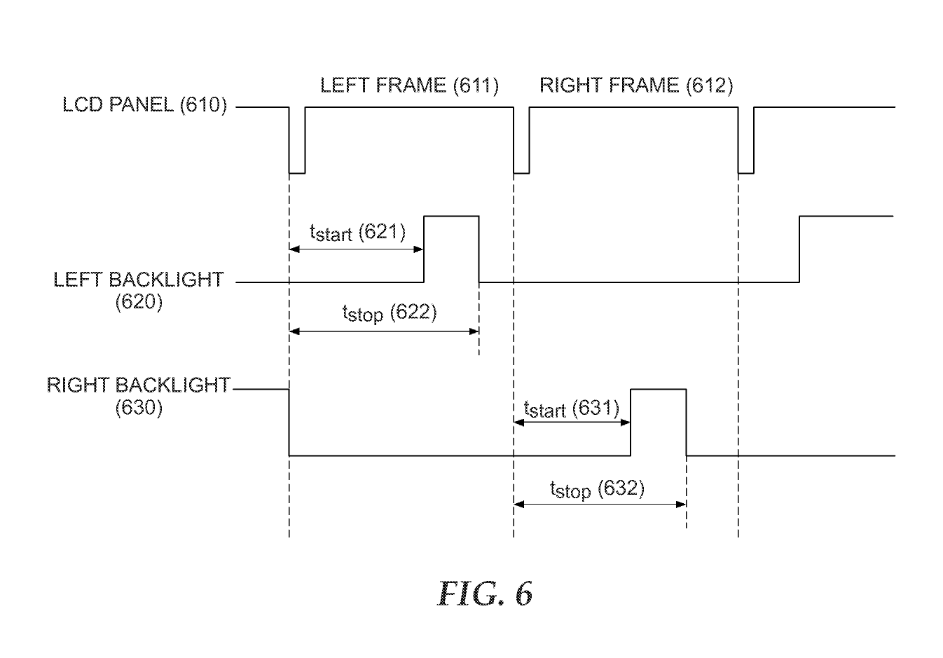

FIG. 6 is an explanatory diagram for a control timing of an LCD panel and a backlight for driving a dual view display according to the exemplary embodiment of the present disclosure.

As illustrated in FIG. 6, when a left frame 611 is displayed on an LCD panel 610, left and right backlights 620 and 630 are turned off at a start time (time=0) of the frame. The left backlight 620 is turned on at a time Tₛₜₐᵣₜ 621. The left backlight 622 is turned off at a time Tₛₜₒₚ 622. By a similar method, when a right frame 612 is displayed on the LCD panel 610, the left and right backlights 620 and 630 are turned off at the start time (time=0) of the frame. The right backlight 630 is turned on at a time Tₛₜₐᵣₜ 631. The right backlight 630 is turned off at a time Tₛₜₒₚ 632.

Here, the times Tₛₜₐᵣₜ 621 and 631 and the times Tₛₜₒₚ 622 and 632 may be set, for example, to values between 0 ms to 8 ms. The times Tₛₜₐᵣₜ 621 and 631 and the times Tₛₜₒₚ 622 and 632 may be optimized in order to remove timing crosstalk according to an LCD response time while maintaining desired luminance and light and shade. In general, the times Tₛₜₒₚ 622 and 632 are present at the end of the frame or before the end of the frame. The values of the times Tₛₜₐᵣₜ 621 and 631 are the same as a value obtained by adding a time for recording all of the lines of a visual video, that is, a video recording time, to the LCD panel response time.

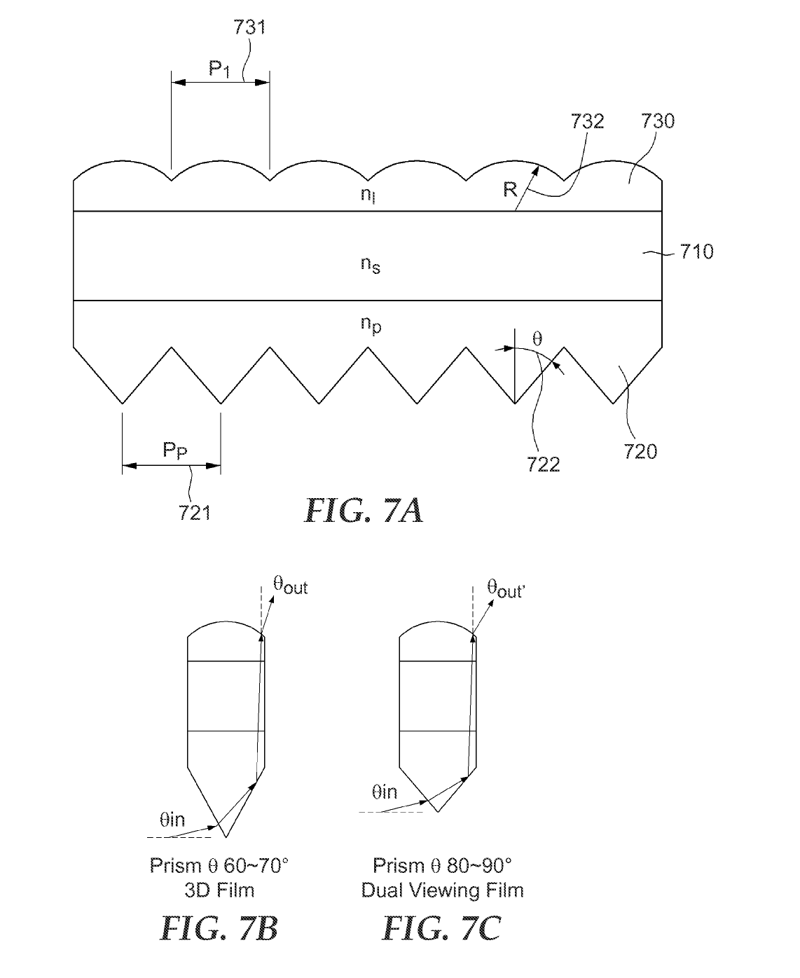

FIGS. 7A and 7B are explanatory diagrams for a structure and a light output angle of a dual viewing film according to an exemplary embodiment of the present disclosure.

A dual viewing film 700 in the dual view display includes a substrate layer 710, a prism input layer 720, and a lens output layer 730.

In film description, the definition of the dual viewing film 700 location is as following. The upper of the dual viewing film 700 means the top side and direction where the viewer see the display while lower of the dual viewing film 700 means the bottom side (opposite side of viewer). And left and right of dual viewing film 700 means the light source position in Backlight where the light source is located to turning light source on and off alternatively. If the driver is located at left, it means the light from right light source directed toward driver side, while the light from left light source directed toward front passenger. The direction of light & position of driver & front passenger can be reversed by country.

A plurality of prisms having a prism apex angle 2×θ 722 and a prism pitch Pₚ 721 at a lower surface of the substrate layer 710 is provided as the prism input layer 720.

The lens output layer 730 is provided with a plurality of lens having a lens pitch Pₗ 731 and a lens curvature radius R 732 as an upper surface of the substrate layer 710.

Here, the light input in the left side or the right side of the prism input layer 720 is reflected, and the reflected light is refracted toward the viewer in the left or right direction deviating from a normal axis of the dual view display through the lens output layer 730. For example, the light refracted from the lens output layer 730 may head toward the viewer in the left or right direction deviating from the normal axis of the dual view display by ±10° or more.

The dual viewing film 700 is for the dual view display, and has a wide turning angle, not a narrow turning angle. In the prismatic structure at the side of the lower surface of the substrate layer 710, a twin light distribution is spread by more widely redirecting the light by increasing the prism apex angle 2×θ 722. The prism input layer 720 can be provided with a plurality of prisms having the prism apex angle 2×θ 722 between, for example, 80° to 90° and the prism pitch Pₚ 721 from, for example, 40 um to 60 um.

The dual viewing film 700 has a different output angle generated by the prismatic structure than from that of a three dimensional (3D) film. The prism apex angle 2×θ 722 is formed to be 90°, and the prism pitch Pₚ 721 is formed to be from 70 um to 50 um. When the input angles are the same in both films, the output angle of the 3D film may be close to the normal axis. In 3D film, prism apex angle is around 60˜70 degree and it direct light toward on-axis while proposed dual viewing film direct light toward more off axis because of prism angle range from 80˜90 degree, which is optimal for both driver and front passenger in the car. Θin is same as for both cases. However, output angle θout and θout′ is not same because of prism angle and its path length differences.

In the meantime, the substrate layer 710 of the dual viewing film 700 is formed, for example, of a poly ethylene terephthalate (PET) substrate. The prism input layer 720 and the lens output layer 730 may be formed of a luminance enhancement resin. Substrate can be PC, PEN, CoPEN as well as PET. But PET is the easiest and stable substrate for a film process forming a geometrically structured pattern. Current invention utilizes acrylic resin which is typically used for structured film.

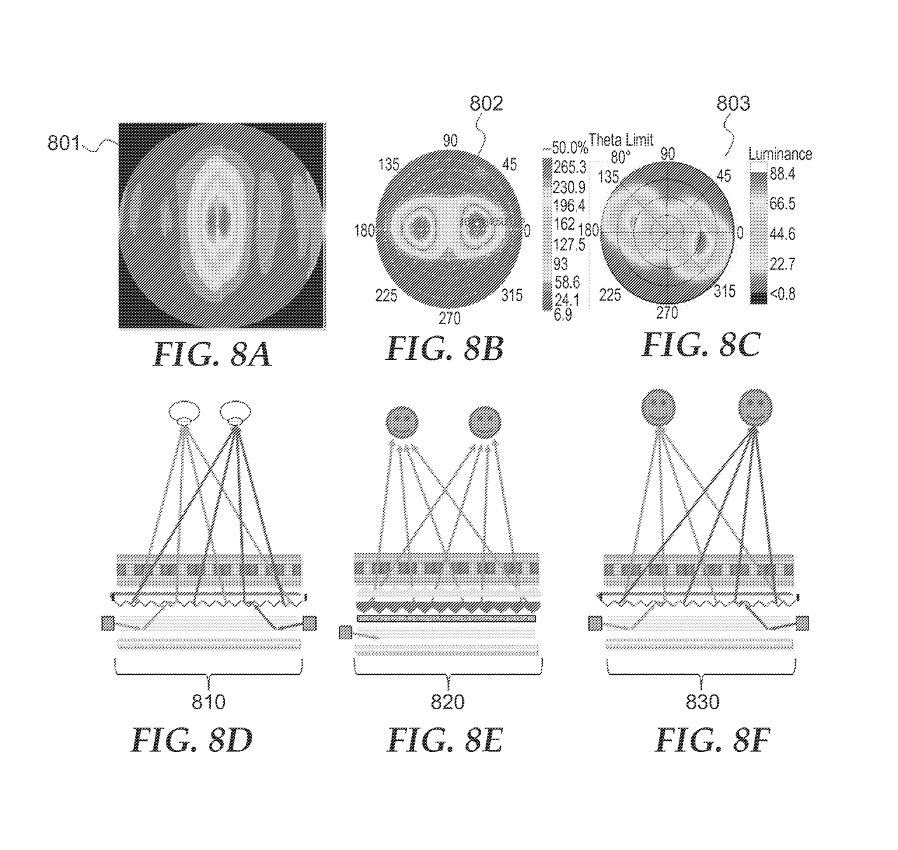

FIGS. 8A-8F are conoscope explanatory diagrams for an angular light distribution in various display structures.

As illustrated in FIGS. 8A-8F, a left drawing 801 represents a 3D autostereoscopic conoscope image of a 3D autostereoscopic display 810, a center drawing 802 represents a two peak conoscope image of a two peaks display 820 having an upper and lower prismatic structure, and a right drawing 803 represents a conoscope image of the dual view display 830.

Specifically, the left drawing 801 is a typical light distribution of the 3D autostereoscopic display 810, and a cross-sectional view of the 3D autostereoscopic display.

The center drawing 802 represents a case of the two peaks display 820, in which different prisms are used at an upper surface and a lower surface, respectively.

The right drawing 803 represents a case of the dual viewing film 830, and represents the conoscope image measured in a structure having the prism angle of 90°, the prism pitch of 50 um, and the lens pitch of 30 um. Here, the measured conoscope image is of the film of FIG. 7 with a slight bias angle in order to decrease pixel moire. The measured conoscope image illustrates an asymmetric light distribution.

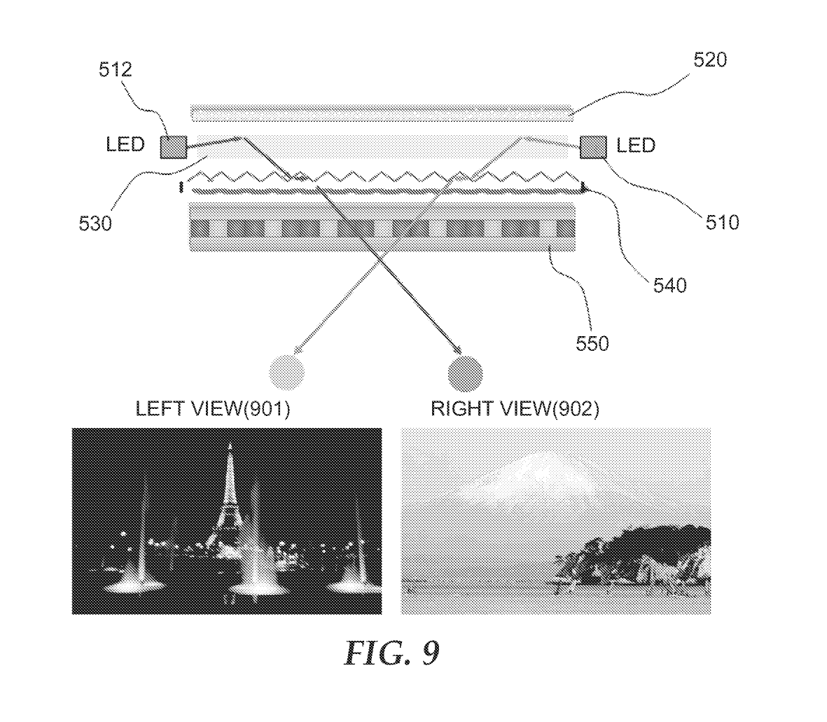

FIG. 9 is an example diagram of left and right views in the dual view display to which the dual viewing film according to the exemplary embodiment of the present disclosure is applied.

As illustrated in FIG. 9, the dual view display according to the exemplary embodiment of the present disclosure includes the left and right edge emitting LEDs 511 and 512, the reflection surface 520, the light guide plate 530 having the pattern, the dual viewing film 540, and the display panel 550. The dual viewing film 540 includes the lens output layer using microreplication having high precision at the upper surface thereof and the prism input layer at the lower surface thereof. 530 light guide has double side structured light guide pattern as below picture top side has lenticular pattern and its pattern is aligned horizontal direction, while bottom side has shallow prism pattern perpendicular to lenticular pattern.

The dual view display can solve a resolution decrease problem generated in the parallax barrier display and improve view reversal for a left view 901 and a right view 902 by using the display panel 550 having a high refresh rate.

The dual view display uses temporal multiplexing which does not decrease resolution of an image as illustrated in the left view 901 and the right view 902. The dual view display continuously displays different images so as to maintain an image with full resolution. A difference between the dual view display and a general LCD display panel is to use the display panel 550 having a high refresh rate (for example, 90 Hz or more), the left and right edge emitting LEDs 511 and 512, and the dual viewing film 540.

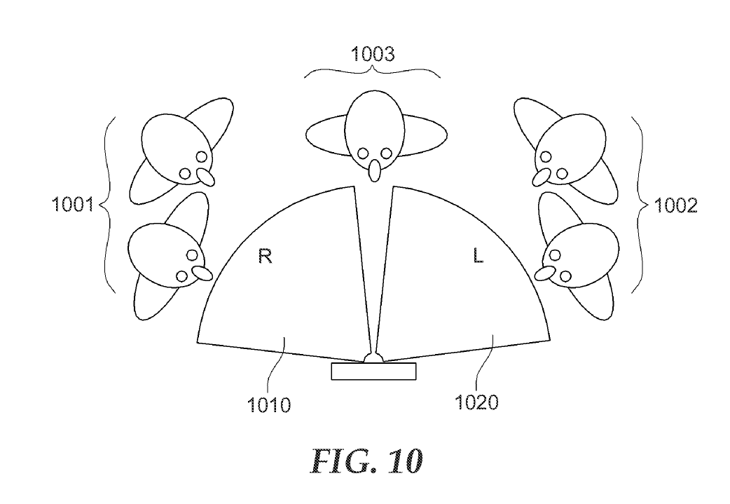

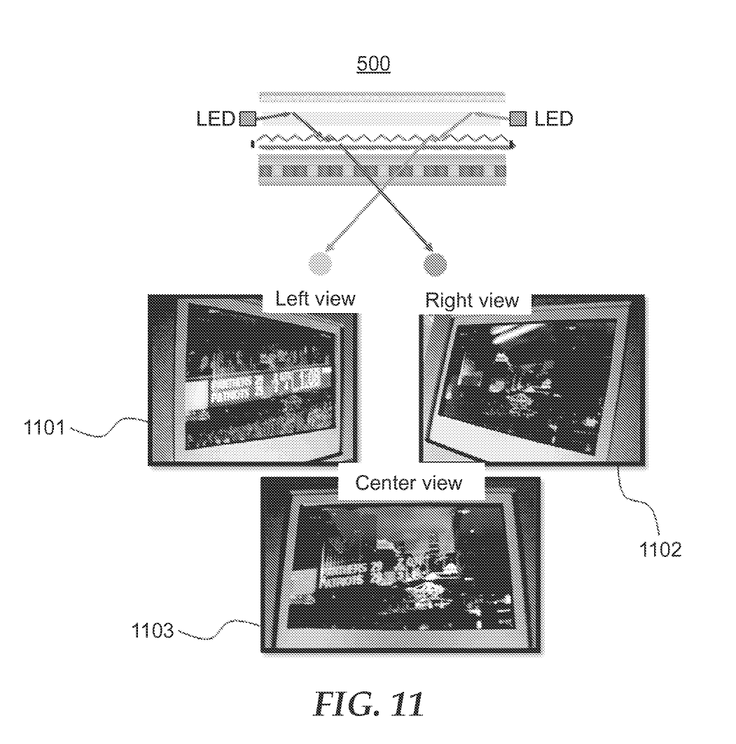

FIGS. 10 and 11 are an explanatory diagram of images viewed by left viewers, a center viewer, and right viewers through the dual view display adopting temporal multiplexing according to the exemplary embodiment of the present disclosure, and an example diagram of the images.

As illustrated in FIG. 10, the dual view display adopting the temporal multiplexing provides a single viewing zone. The dual view display adopting the temporal multiplexing provides right users 1001 and left users 1002 with a right image R and a left image L, of which resolution of an image is not reduced, respectively. That is, the temporal multiplexing does not exert an influence on the resolution and view reversal of an original image. However, the center user 1003 views an image in which the right image R and the left image L are combined.

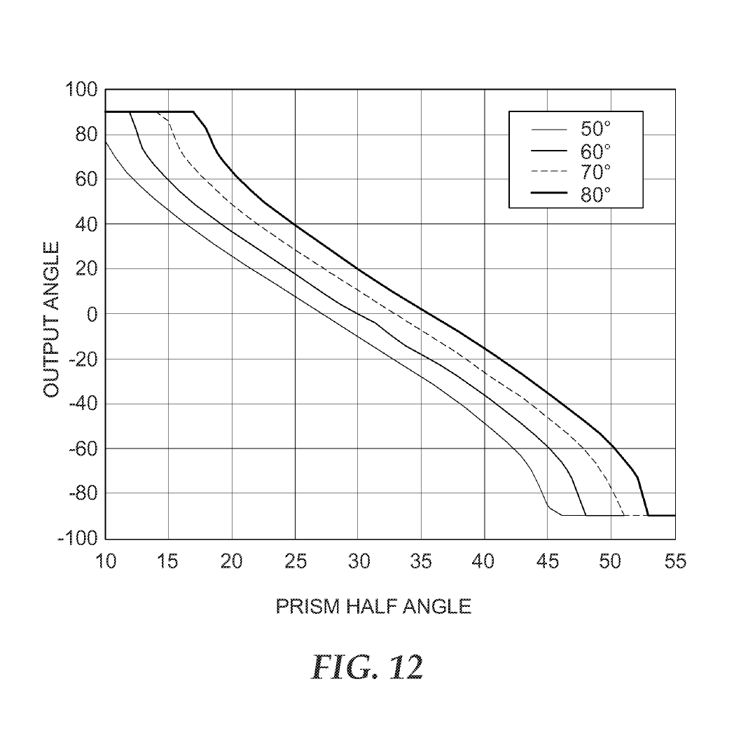

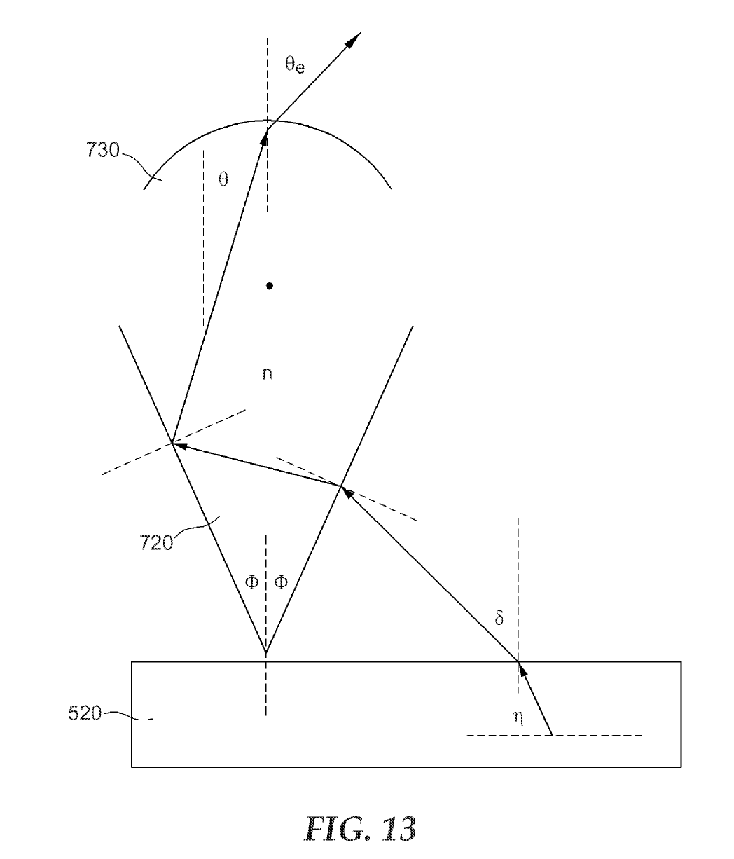

As illustrated in FIG. 11, the dual view display 500 adopting the temporal multiplexing displays different images by using the dual viewing film having a prism angle of 90°, a prism pitch of 50 um, and a lens at the upper surface thereof. FIGS. 12 and 13 are explanatory diagrams of the dual viewing film for an output angle simulation by a prism apex angle and an input angle and an output angle calculation process according to the exemplary embodiment of the present disclosure.

The prism apex angle is equal to or larger than 80° in order to symmetrically axially moving a light distribution.

As illustrated in FIG. 12, in a case where a prism half angle ranges from 10° to 55°, and an input angle ranges from 50° to 80°, a simulation of the output angle of the dual viewing film is represented.

Based on the simulation, an output angle is represented at which the light incident from the light guide plate 520 illustrated in FIG. 13 is output through the prism input layer 720 and the lens output layer 730.

A half angle Ø of the prism is determined in order to make an output angle θₑ at a specific off axis of the dual viewing film. Equation 1 below is an equation prior to an angle of light between the light guide plate 520, the prism input layer 720, and the lens output layer 730.

$$sin {θ}_{e} = n sin θ \\ δ = - φ + {cos}^{- 1} [ n cos ( θ + 3 φ ) ] \\ η = {cos}^{- 1} ( \frac{sin δ}{{n}_{1 g}} ) \qquad [ Equation 1 ]$$

Here, η represents an incident angle of an emission surface to a normal line in the light guide plate 520, δ represents a refraction angle for the normal line of the emission surface of the light guide plate 520, n_{lg} represents a refractive index of the light guide plate 520, n represents a refractive index of a lens output layer 730, θₑ represents a refraction angle for a normal line of the lens output layer 730, θ represents an incident angle for the normal line of the lens output layer 730, and Ø represents an apex half angle of the prism input layer 720.

According to Equation 1, in a case where the apex half angle Ø of the prism input layer 720 is 30°, and the refractive indexes n_{lg} and n of the light guide plate 520 and the lens output layer 730 is 1.5, when the refraction angle θₑ is 7° with respect to the normal line of the lens output layer 730, the refraction angle δ and the incident angle η for the normal line of the emission surface of the light guide plate 520 are approximately 67° and 52°, respectively.

For example, when a position of the viewer is at 40° from an on-axis, the input angle of the light for the dual view display is 70°. The prism half angle may be 43°. The dual view display may be implemented so that the light heads toward the viewer based on the output angle of the dual viewing film.

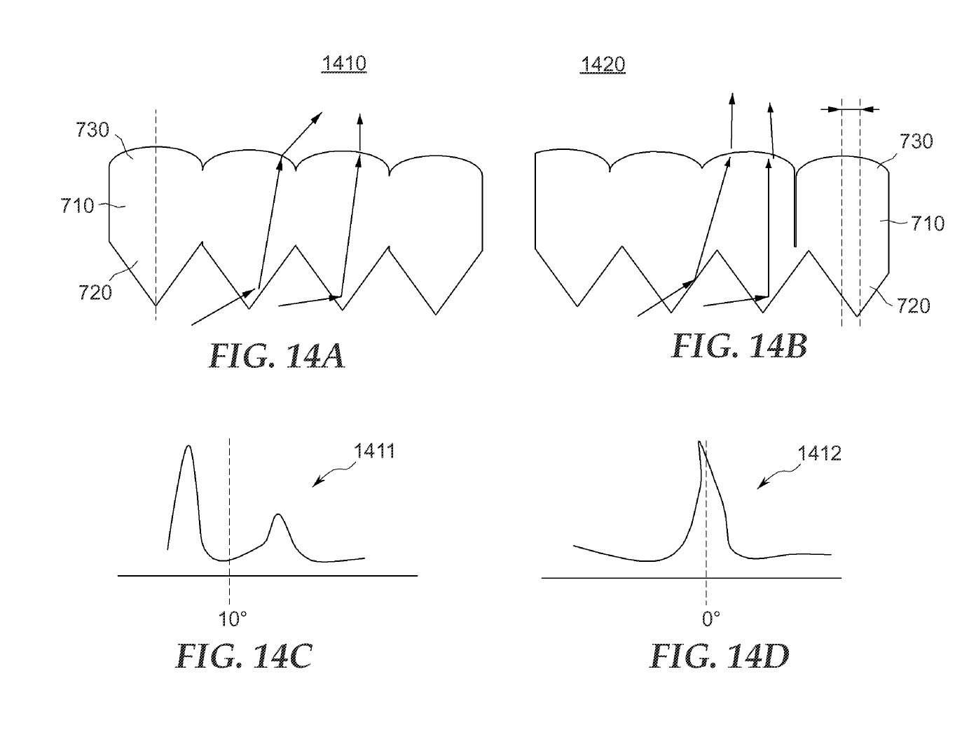

FIGS. 14A-14D are explanatory diagrams for crosstalk according to a peak deviation between the prism input layer and the lens output layer according to the exemplary embodiment of the present disclosure.

A left dual viewing film 1410 is a case where a peak between the prism input layer 720 and the lens output layer 730 is not misaligned, so that there is no peak deviation and the peak is accurately aligned. To investigate a distribution of light of the left dual viewing film 1410, a different input angle (for example, 10°) results in crosstalk.

Crosstalk refers to the incomplete isolation of the left and right image channels and it means a phenomenon that the images are superimposed. So that one leaks or bleeds into the other like a double exposure. And the crosstalk refers to ratio of light intensity between left light source and right light source at viewing angle having maximum light intensity of Left or Light. If the maximum light intensity from Left LED and its position is 1, 30 degree respectively, light intensity from Right LED at 30 degree is 0.1, then the crosstalk is 0.1/1=10%. The less crosstalk is, the less bleeding, which can provide more comfortable view to viewer. There are many different crosstalk level in 3D and it is not easy to determined the preferable crosstalk level because the level of crosstalk is quite depend on viewer's distance between two eyes and subjective feeling. This invention showed that proposed invention crosstalk level can be 0.47% to 1%, which is very low crosstalk level compared over 5% crosstalk in autostereoscopic 3D.

Both 1410 and 1420 explains the example of misalignment between prism peak and lenticular peak. 1410 is when there is no misalignment between prism peak and lenticular peak and its crosstalk is 7.75% according to modeling result in table 1. 1420 is when there is 5 um misalignment and the crosstalk level is reduced to 0.94% by optical modeling in the table 1.

However, a right dual viewing film 1420 is a case where a peak center between the prism input layer 720 and the lens output layer 730 is misaligned, so that there is a peak deviation. To investigate the distribution of light of the right dual viewing film 1420, it can be seen that the misalignment does not cause any overlap between the prism input layer 720 and the lens output layer 730, thereby reducing the crosstalk. That is, as investigated in the example of the right dual viewing film 1420, the peak center of the prism pitch Pp of the prism input layer 720 and the lens pitch Pₗ of the lens out layer 730 is misaligned so that the crosstalk of the dual view display is decreased to be equal to or lower than a predetermined value. For example, the peak deviation X between the prism pitch Pₚ of the prism input layer 720 and the lens pitch Pₗ of the lens output layer 730 is represented by Equation 2.

Pl−Pp=X, Pl/Pp=N, 0.05<X/Pp<1.3 [Equation 2]

Here, Pₗ represents a lens pitch, Pₚ represents a prism pitch, and X represents a peak deviation.

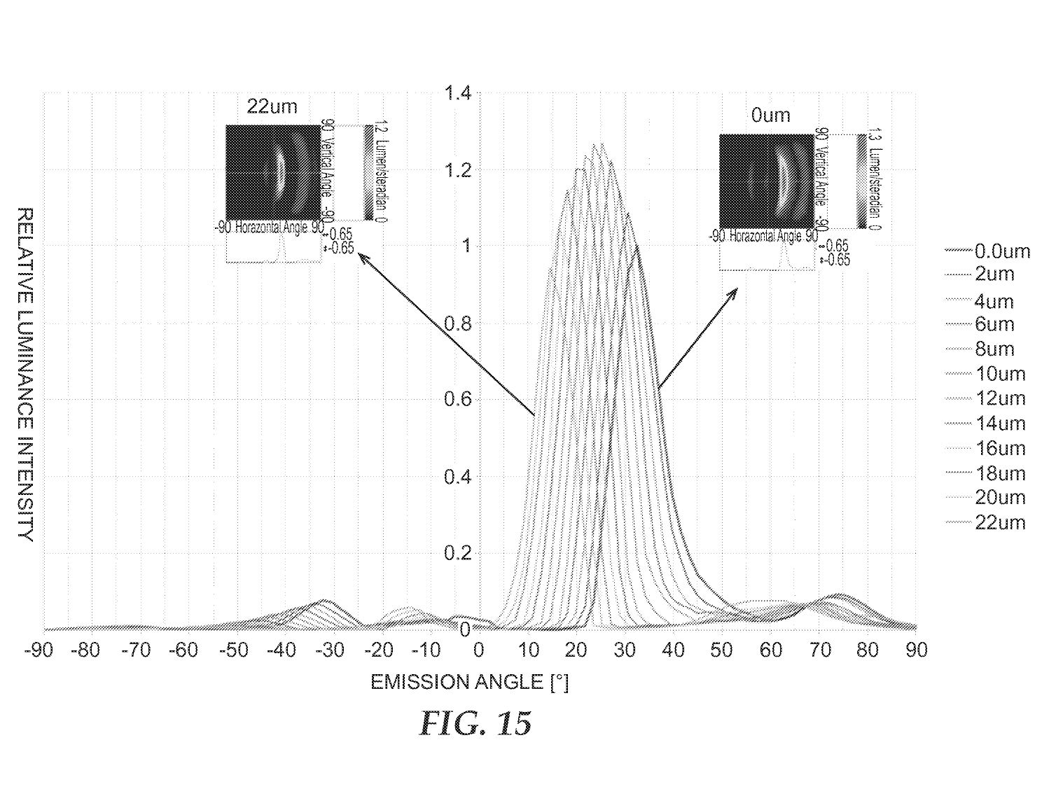

FIG. 15 is an explanatory diagram for a viewing angle distribution simulation according to a peak deviation between the prism input layer and the lens output layer according to the exemplary embodiment of the present disclosure.

A result graph of the viewing angle distribution simulation according to a peak deviation between the prism input layer 720 and the lens output layer 730 is illustrated in FIG. 15, and a simulation result table is represented as Table 1 below. The prism angle for a crosstalk simulation is fixed, and a peak misalignment value is changed from 0 um to 22 um.

TABLE 1

| | Pitch change [um] | | | | | | | | | | | |
|---|---|---|---|---|---|---|---|---|---|---|---|---|
| | 0 | 2 | 4 | 6 | 8 | 10 | 12 | 14 | 16 | 18 | 20 | 22 |
| Viewing angle [°] | 32.4 | 30.6 | 28.8 | 27 | 25.2 | 23.4 | 21.6 | 19.8 | 19.8 | 18 | 16.2 | 14.4 |
| Crosstalk | 7.75% | 4.67% | 1.56% | 0.46% | 0.62% | 0.86% | 1.33% | 1.33% | 0.64% | 1.31% | 4.17% | 6.41% |
| Relative | 1.00 | 1.09 | 1.14 | 1.22 | 1.27 | 1.27 | 1.24 | 1.20 | 1.17 | 1.15 | 1.06 | 0.94 |
| luminance | | | | | | | | | | | | |
| intensity [a.u.] | | | | | | | | | | | | |

The crosstalk simulation result of Table 1 shows that a case where the peak difference is 0 um has the peak angle of 32.4° with the crosstalk of 7.75%. A case where the peak difference is 4 um has the peak angle of 28.04° with the crosstalk of 1.56%. In comparison with the cases from 0 um to 22 um, the peak-to-peak misalignment between the prism input layer 720 and the lens output layer 730 remarkably improves the crosstalk. This is for the purpose of improving system performance and amplifying maximum luminance.

To investigate the simulation result, the dual viewing film according to the exemplary embodiment of the present disclosure may maintain minimum crosstalk (5% or lower) and have maximum on-axis luminance. When the value of the peak-to-peak pitch between the prism pitch of the prism input layer and the lens pitch of the lens output layer is misaligned in a range from 0 um to 20 um, the viewing angle of the dual viewing film is minimally 14.4° or more. Here, more preferably, the dual viewing film may be implemented in a structure in which the prism apex angle is changed within a range from 85° to 90°, and the peak-to-peak misalignment is in a range from 0 m to 7 um.

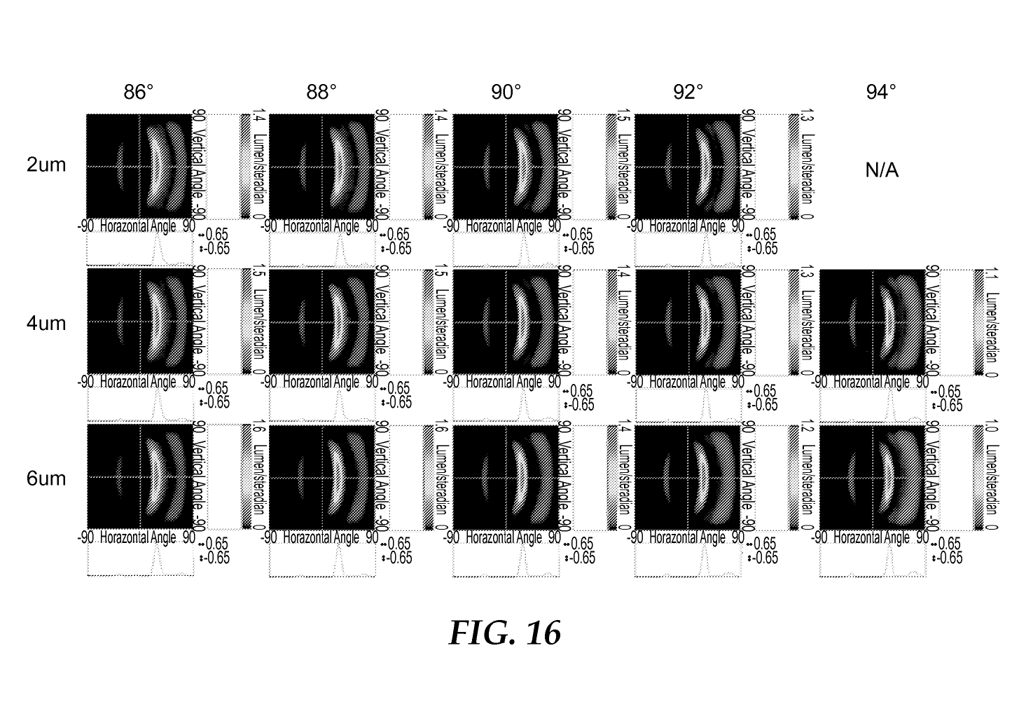

FIG. 16 is an explanatory diagram for an optical simulation result according to a prism angle and a peak-to-peak deviation according to the exemplary embodiment of the present disclosure.

An optical simulation graph under the condition of different peak-to-peak misalignments and different prism angles is illustrated in FIG. 16, and an optical simulation result table is represented in Table 2 below.

TABLE 2

| | 86° | | | 88° | | | 90° | | | 92° | | | 94° | |
|---|---|---|---|---|---|---|---|---|---|---|---|---|---|---|
| | 2 | 4 | 6 | 2 | 4 | 6 | 2 | 4 | 6 | 2 | 4 | 6 | 4 | 6 |
| Viewing | 30.6 | 28.8 | 27 | 30.6 | 28.8 | 27 | 30.6 | 28.8 | 28.8 | 30.6 | 28.8 | 28.8 | 30.6 | 28.8 |
| angle [°] | | | | | | | | | | | | | | |
| Crosstalk | 4.67% | 1.56% | 0.46% | 4.64% | 1.63% | 0.12% | 4.67% | 1.69% | 0.25% | 4.57% | 1.33% | 0.19% | 3.13% | 0.30% |
| Relative | 1.00 | 1.05 | 1.12 | 1.03 | 1.06 | 1.12 | 1.05 | 0.99 | 1.03 | 0.96 | 0.90 | 0.88 | 0.88 | 0.77 |
| luminance | | | | | | | | | | | | | | |
| intensity [a.u.] | | | | | | | | | | | | | | |

According to Table 2, a range in which the crosstalk is small and the relative luminance is high is a case where the prism angle is 86° and the peak deviation is 4 um to 6 um, a case where the prism angle is 88° and the peak deviation is 4 um to 6 um, and a case where the prism angle is 90° and the peak deviation is 6 um.

According to Table 2, cases having the peak-to-peak deviation of 4 um to 6 um and the prism angles of 86°, 88°, and 90° may have the lowest crosstalk and maximum luminance. A case where the crosstalk is at the minimum is a case where the peak-to-peak deviation is 6 um and the prism angle is 88°. A case where the luminance is at the maximum is a case where the peak-to-peak deviation is 6 um and the prism angle is 86°, and a case where the peak-to-peak deviation is 6 um and the prism angle is 88°.

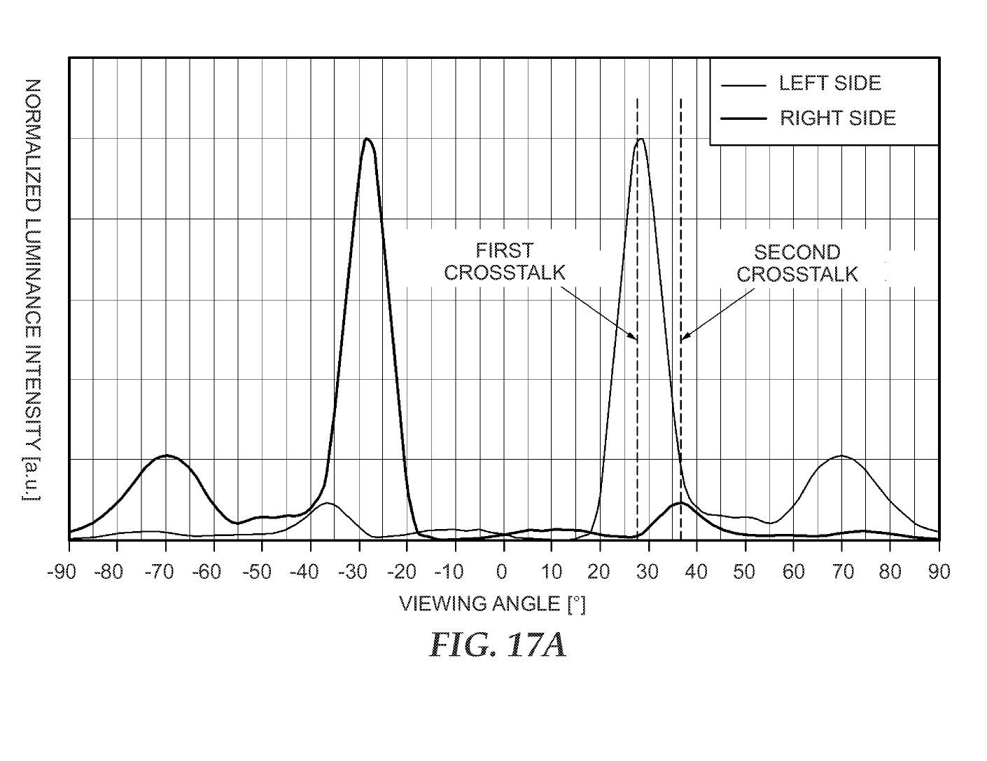

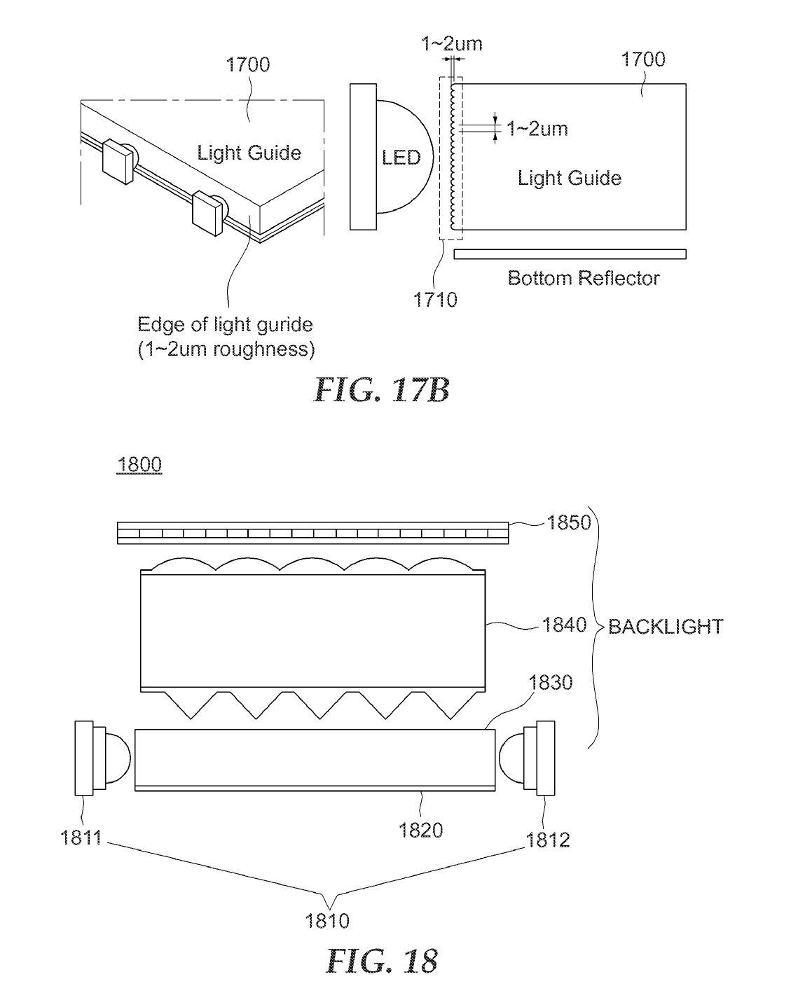

FIGS. 17A and 17B are explanatory diagrams for first and second crosstalk generated in the dual viewing film of the present disclosure.

An analysis result of a case where the peak-to-peak deviation is fixed to 5 um is represented in Table 3 below, and a graph for the first and second crosstalk is illustrated in FIGS. 17A and 17B.

TABLE 3

| | Prism angle [°] | | | | | |
|---|---|---|---|---|---|---|
| | 86 | 87 | 88 | 89 | 90 | |
| Prism pitch [um] | 5 | 5 | 5 | 5 | 5 | 6 |
| Viewing angle [°] | 28.8 | 28.8 | 28.8 | 28.8 | 28.8 | 27 |
| First crosstalk [%] | 1.92 | 1.89 | 1.62 | 1.55 | 1.79 | 0.55 |
| Second crosstalk [%] | 41 | 46 | 53 | 57 | 58 | 54 |
| Relative luminance | 1.00 | 0.97 | 0.95 | 0.90 | 0.84 | 0.83 |
| intensity | | | | | | |

According to Table 3, in a case where the prism angle is 88° among the 5 different prism angles, the crosstalk is low and the luminance is high. Since the number of the viewers of the dual viewing display is two, a crosstalk level at both positions needs to be considered. A crosstalk level when the viewer views the display needs to be considered.

As illustrated in FIGS. 17A and 17B, the first crosstalk is represented as a ratio obtained by dividing a maximum luminance value from one LED by a luminance value from the other LED at the maximum luminance viewing angle. The first crosstalk is represented with a low level. On the other hand, light of the LED reflected back from the light guide plate at the opposite side generates the second crosstalk.

The second crosstalk fundamentally caused from the back reflection may be minimized by a pattern treatment of a reflected edge surface of the light guide plate 1700. Pattern treatment 1710 to minimize reflected edge surface of light guide is horizontal 1-2 um pitch and 1-2 um depth pattern.

A level of the second crosstalk is relatively high due to the back reflection, and thus may be minimized by the dual viewing film on which the edge surface treatment, such as a light guide plate modification and black masking is performed.

FIG. 18 is a configuration diagram of a dual view display apparatus using the dual viewing film according to the exemplary embodiment of the present disclosure.

As illustrated in FIG. 18, a dual view display apparatus 1800 according to the exemplary embodiment of the present disclosure includes a left and right light source including left and right LED light sources 1811 and 1812, a reflection surface 1820, a light guide plate 1830, a dual viewing film 1840, and a display panel 1850.

The left and right light source 1810 outputs light in a left direction or a right direction according to continuous left and right timings. The left and right light source 1810 includes the left LED light source 1811 and the right LED light source 1812. Here, the left and right LED light sources 1811 and 1812 may have the same luminance intensity or different luminance intensities on both side surfaces of the dual view display apparatus 1800.

The reflection surface 1820 reflects back the light output from the left and right light source 1810.

The light guide plate 1830 guides a path of the light output from the left and right light source 1810.

The dual viewing film 1840 includes a prism input layer in which a plurality of prisms is continuously formed at a lower surface thereof, and a lens output layer in which a plurality of lens is continuously formed at an upper surface thereof. The dual viewing film 1840 reflects light input in the left side or the right side of the prism input layer from the light guide plate 1830, and refracts the reflected light to head toward a viewer in a left or right direction deviating from a normal axis of the dual view display through the lens output layer. Here, the prism input layer has a pattern perpendicular to a light emission direction of the left and right light source 1810 at the lower surface of the dual viewing film 1840. The lens output layer has a pattern parallel to the light emission direction of the left and right light source 1810 at the upper surface of the dual viewing film 1840.

The display panel 1850 displays different images to the viewer in the left or right direction by using the light refracted from the dual viewing film 1840. The display panel 1850 has a higher refresh rate than that of a general LCD display panel. That is, the display panel 1850 may display different images to the viewer in the left or right direction through a liquid crystal display by reproducing the different images with a predetermined refresh rate or more.

In the meantime, the dual viewing film 1840 has an asymmetric light output distribution due to a pitch deviation between patterns of an upper lens and a lower prism in the left and right LED light sources 1811 and 1812 having the same luminance intensity. This is for the purpose of reducing the crosstalk.

However, the dual view display apparatus 1800 having the left and right LED light sources 1811 and 1812 having the different luminance intensities at the left side and the right side may have a symmetric light output distribution, not the asymmetric light output distribution.

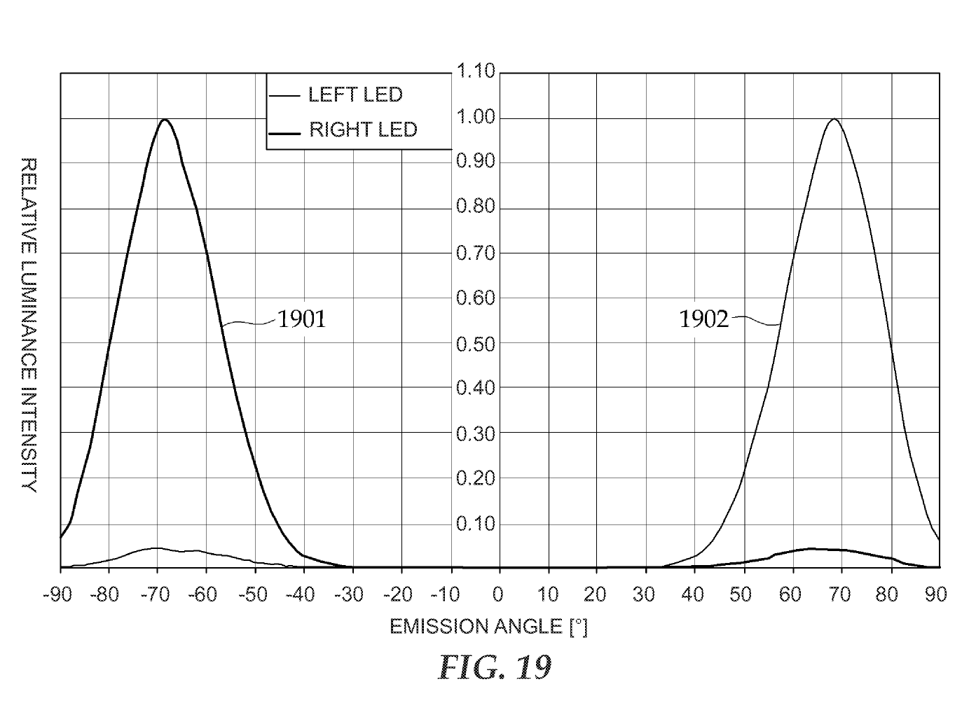

FIG. 19 is an explanatory diagram for an optical simulation result of a light output distribution using the light guide plate with the dual side LEDs applied to the present disclosure.

A right light output distribution curved line 1902 shows a light output for a single side input using the left LED light source 1811 in the dual view display apparatus 1800. On the other hand, a left light output distribution curved line 1901 shows a light output for a single side input using the right LED light source 1812 in the dual view display apparatus 1800. That is, according to the result of FIG. 19, the light output of the light guide plate 1820 having the left and right light source 1810 is symmetrically distributed.

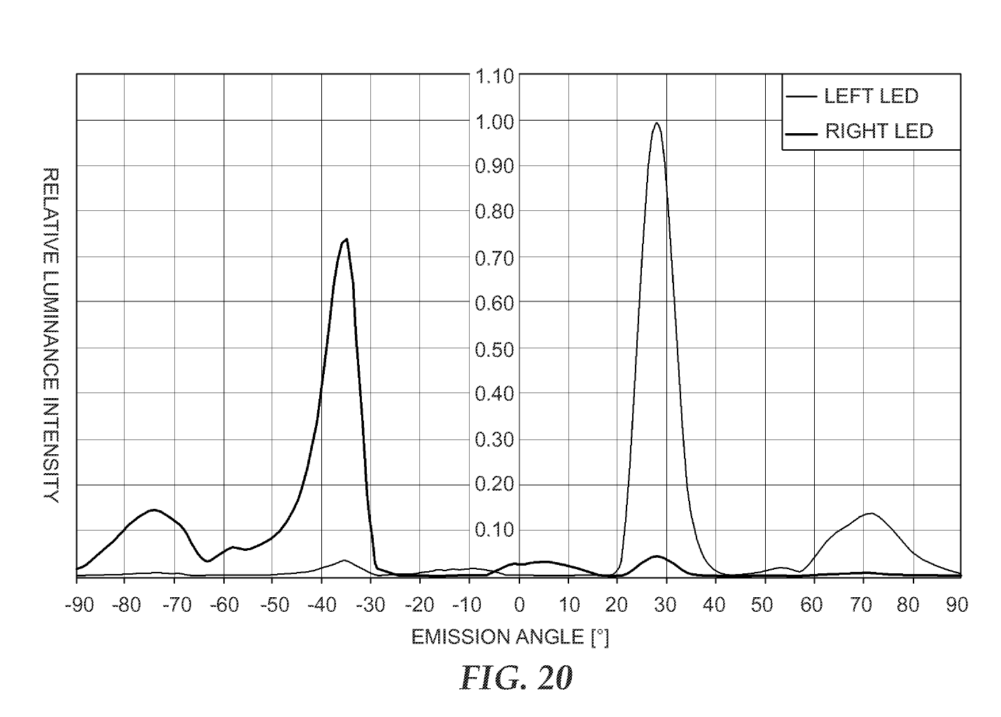

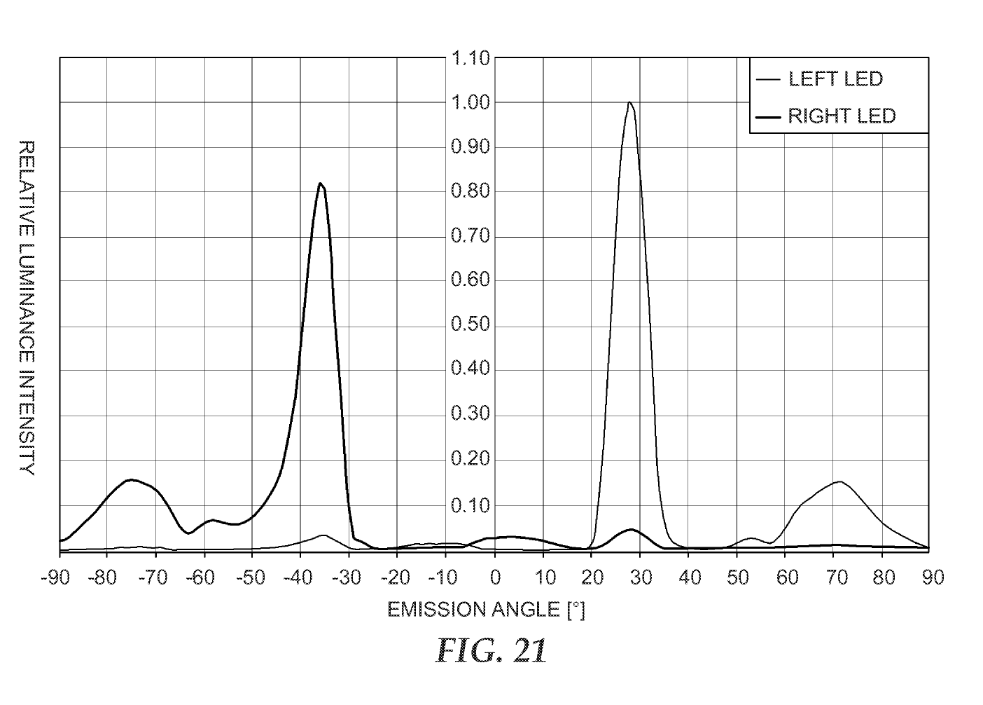

FIGS. 20 and 21 are explanatory diagrams for an optical simulation result using two types of dual viewing films according to the exemplary embodiment of the present disclosure.

An optical simulation result of the dual viewing film having a prism angle of 86° and a pitch deviation of 5 um is represented in FIG. 20. An optical simulation result of the dual viewing film having a prism angle of 88° and a pitch deviation of 5 um is represented in FIG. 21. As illustrated in FIGS. 20 and 21, the dual viewing film has the asymmetric light distribution due to a pitch deviation between the upper surface and the lower surface of the dual viewing film in the optical simulation result. According to a result of the optical simulation using two types (86°/5 um and 88°/5 um) of dual viewing films, the light output by the right LED light source 1812 is 30% or lower than that of the left LED light source 1811.

According to the result, the asymmetric light input is necessary in the dual viewing film. In a case where the pitch deviation exists between the prism input layer and the lens output layer of the dual viewing film, the left and right LED light sources 1811 and 1812 output light with different luminance intensities in the left direction and the right direction, respectively, so as to have the asymmetric light distribution. For example, the luminance intensity of the right LED light source 1812 may be set to be minimally 20% or more than the left LED light source 1811. Here, an emission angle of the right LED light source 1812 is the same as that of the left LED light source 1811.

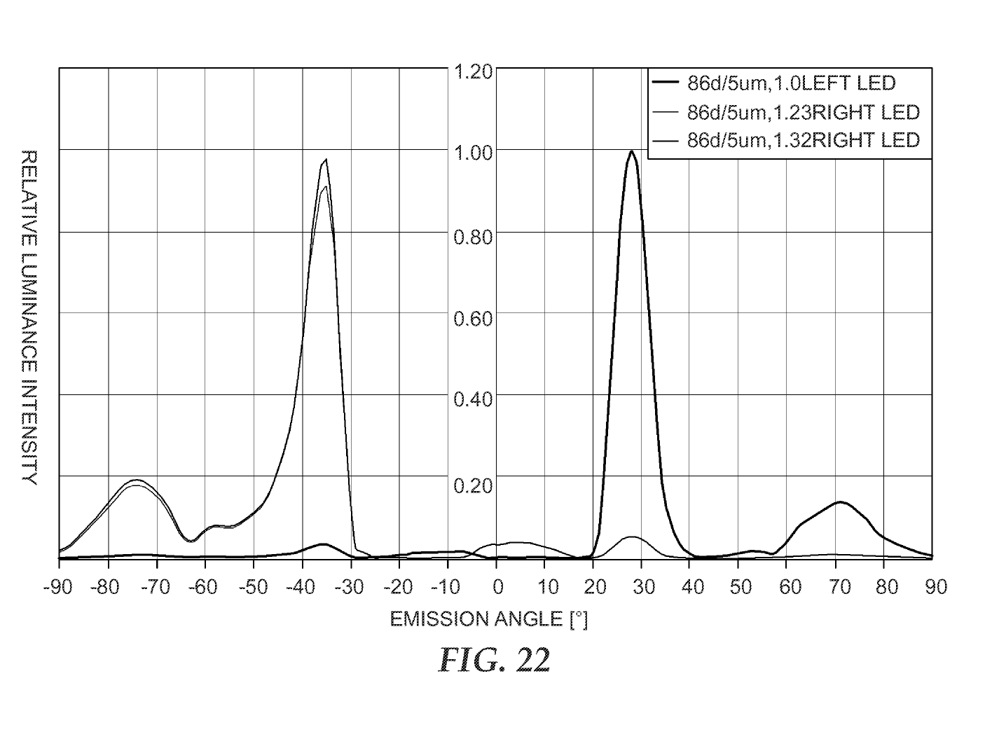

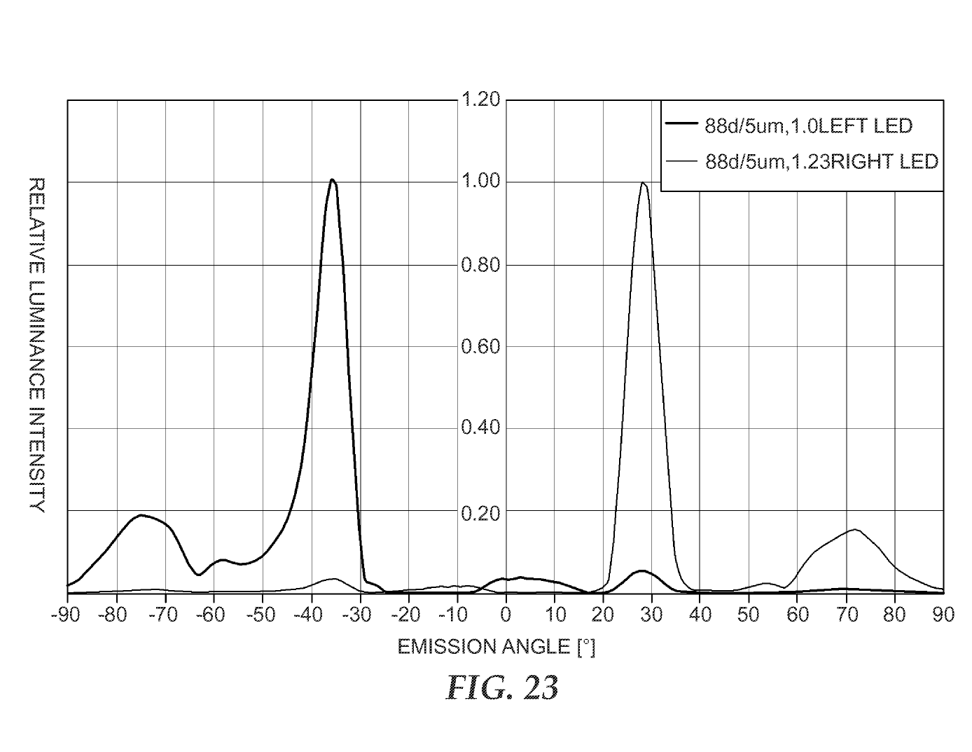

FIGS. 22 and 23 are explanatory diagrams for a light output distribution of the dual view display apparatus using light sources having different luminance intensities according to the exemplary embodiment of the present disclosure.

The graphs illustrated in FIGS. 22 and 23 relate to the dual view display apparatus using the dual viewing film having the prism angle of 86° and the pitch deviation of 5 um.

FIG. 22 represents light output distributions for the left LED light source having a luminance intensity of 1.0, the right LED light source having a luminance intensity of 1.23, and the right LED light source having a luminance intensity of 1.32. Specifically, the light output distribution for the right LED light source having the luminance intensity of 1.23 has an asymmetric output distribution compared to the light output distribution for the left LED light source having the luminance intensity of 1.0. On the contrary, the light output distribution for the right LED light source having the luminance intensity of 1.32 has a symmetric output distribution compared to the light output distribution for the right LED light source having the luminance intensity of 1.23.

In FIG. 23, the light outputs for the left LED light source having the luminance intensity of 1.0 and the right LED light source having the luminance intensity of 1.23 have the symmetric distribution. As a result, the dual view display apparatus has the light sources having different intensities at both sides of the backlight considering the left or right directional distribution for the symmetric light output distribution. This is for the purpose of symmetrically changing the asymmetric light output by the pitch deviation of the dual viewing film.

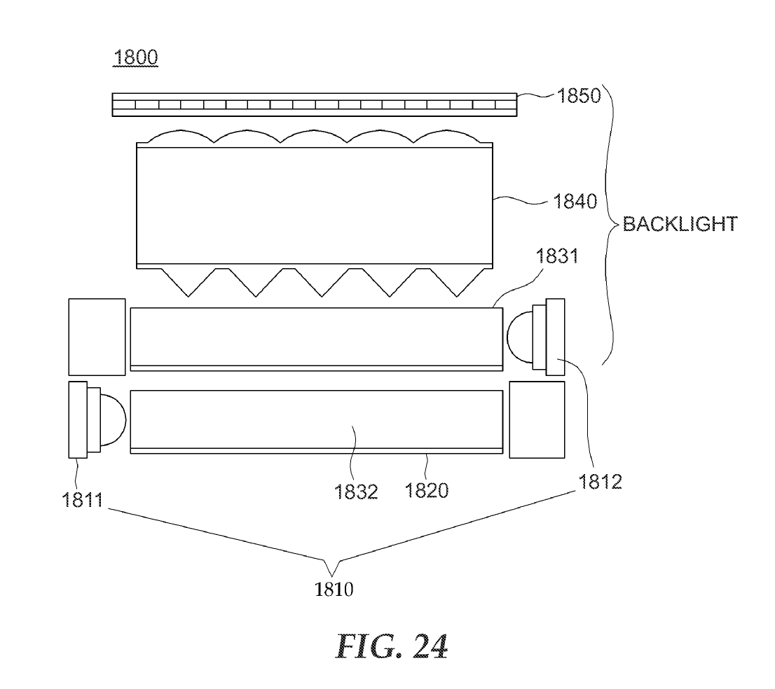

FIG. 24 is a configuration diagram of a dual view display apparatus using a dual light guide plate according to the exemplary embodiment of the present disclosure.

As illustrated in FIG. 24, the dual view display apparatus 1800 using the dual light guide plate according to the exemplary embodiment of the present disclosure includes the left and right light source 1810 including left and right LED light sources 1811 and 1812, the reflection surface 1820, a dual light guide plate including first and second light guide plates 1831 and 1832, the dual viewing film 1840, and the display panel 1850.

In the dual viewing film having the peak deviation, light input by the left and right LED light sources 1811 and 1812 having an asymmetric luminance intensity is necessary. When the luminance intensities of the left and right LED light sources 1811 and 1812 are not modified, the first and second light guide plates 1831 and 1832 enables the symmetric light output distribution even in the dual view display apparatus 1800 including the left and right LED light sources 1811 and 1812 having the same luminance intensities.

Specifically, the dual light guide plate includes the first and second light guide plates 1831 and 1832 positioned in a horizontal direction, and the first and second light guide plates 1831 and 1832 are combined with the left and right LED light sources 1811 and 1812, respectively. The right LED light source 1812 is combined with the first light guide plate 1831, and the left LED light source 1811 is combined with the second light guide plate 1832. The dual light guide plate including the first and second light guide plates 1831 and 1832 guides paths of the light output from the left and right light sources through the combined first and second light guide plates 1831 and 1832, respectively. When the first light guide plate 1831 and the second light guide plate 1832 are positioned at an upper surface and a lower surface of the dual light guide plate, respectively, an air gap may be formed between an upper surface of the second light guide plate 1832 and the lower surface of the first light guide plate 1831. The first and second light guide plates 1831 and 1832 have the same continuous lens pattern and prism pattern on the upper and lower surfaces, similar to the single light guide plate.

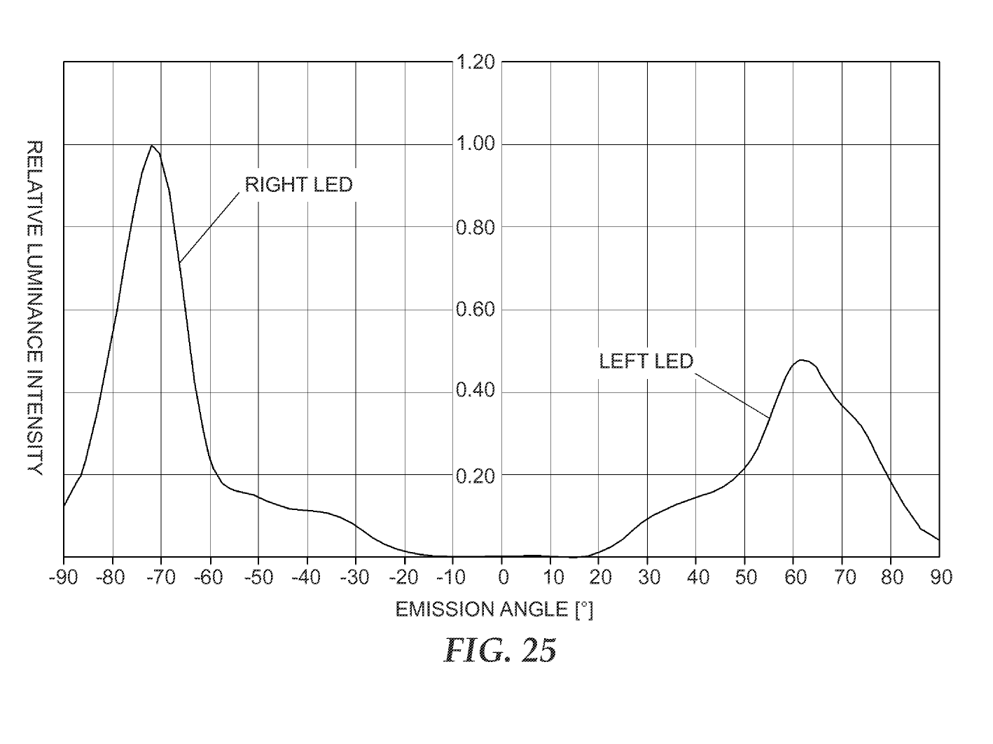

FIG. 25 is an explanatory diagram for an asymmetric optical simulation result of the dual light guide plate combined with the same light source according to the exemplary embodiment of the present disclosure.

As illustrated in FIG. 25, the dual light guide plate by the same left and right LED light sources 1811 and 1812 has the asymmetric light output distribution. The light output distribution of the first light guide plate 1831 combined with the right LED light source 1812 has a distribution lower than the light output distribution of the second light guide plate 1832 combined with the left LED light source 1811.

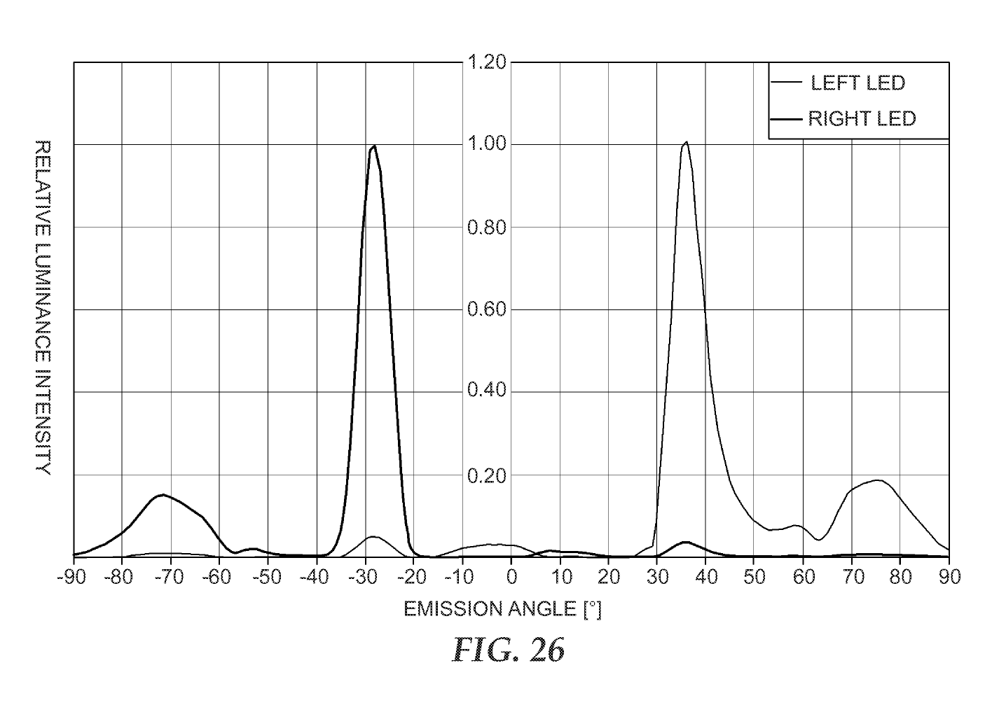

FIG. 26 is an explanatory diagram of an optical simulation result for the dual view display apparatus using the dual light guide plate according to the exemplary embodiment of the present disclosure.

As illustrated in FIG. 26, the dual view display apparatus 1800 using the dual light guide plate having the asymmetric light output distribution has the symmetric light output distribution. When the luminance intensities of the left and right LED light sources 181 and 1812 are not available to be modified, the dual view display apparatus 1800 using the dual light guide plate may be applied.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A dual viewing film in a dual view display, comprising:
a substrate layer;
a prism input layer formed on a lower surface of the substrate layer and provided with a plurality of prisms having a prism apex angle and a prism pitch; and
a lens output layer formed on an upper surface of the substrate layer and provided with a plurality of lens having a lens pitch and a lens curvature radius,
wherein light input in a left side or a right side of the prism input layer is reflected, and the reflected light is refracted so as to head toward a viewer in a left or right direction deviating from a normal axis of the dual view display through the lens output layer.

2. The dual viewing film of claim 1, wherein the light refracted from the lens output layer heads toward the viewer in the right or left direction deviating by ±10° or more from the normal axis of the dual view display.

3. The dual viewing film of claim 1, wherein the prism input layer is provided with the plurality of prisms having the prism apex from 80° to 90°, and the prism pitch from 40 um to 60 um.

4. The dual viewing film of claim 1, wherein peak centers of the prism pitch of the prism input layer and the lens pitch of the lens output layer are misaligned so that crosstalk of the dual view display is decreased to a value equal to or lower than a predetermined value.

5. The dual viewing film of claim 4, wherein a peak-to-peak pitch value between the prism pitch of the prism input layer and the lens pitch of the lens output layer is misaligned within a range from 0 um to 20 um.

6. A dual view display apparatus using a dual viewing film, comprising:
a light guide plate configured to guide a path of an output light;
left and right light sources configured to be adjacent to the light guide at the both edge of the light guide to guide a path of the output light and output light in a left direction or a right direction according to continuous left and right timings;
a reflection surface configured to on bottom of the light guide to reflect back the light from the light guide and reflect back the output light;
a dual viewing film including a prism input layer, in which a plurality of prisms is continuous across the entire lower surface thereof, and a lens output layer, in which a plurality of lens is continuous across entire upper surface thereof, configured to on top of the light guide to direct light from both light sources and reflect light input in a left side or a right side of the prism input layer from the light guide plate, and refract the reflected light so as to head toward a viewer in a left or right direction deviating from a normal axis of the dual view display through the lens output layer; and
a display panel configured to on top of dual viewing film and display different images to the viewer in the left or right direction by using the refracted light.

7. The dual view display apparatus of claim 6, wherein the prism input layer has a pattern perpendicular to light emission directions of the left and right light sources at a lower surface of the dual viewing film, and the lens output layer has a pattern perpendicular to the light emission directions of the left and right light sources at an upper surface of the dual viewing film.

8. The dual view display apparatus of claim 6, wherein a pitch deviation exists between the prism input layer and the lens output layer of the dual viewing film, and the left and right light sources output light with different luminance intensities in the left direction and the right direction, respectively, so as to have an asymmetric light distribution.

9. The dual view display apparatus of claim 6, wherein the light guide plate includes first and second light guide plates positioned in a horizontal direction, the first and second light guide plates are combined with the left and right light sources, respectively, and paths of the light output from the left and right light sources are guided through the combined first and second light guide plates, respectively.

10. The dual view display apparatus of claim 9, wherein the first light guide plate and the second light guide plate are positioned at an upper surface and a lower surface of the light guide plate, respectively, such that an air gap is formed between the upper surface of the second light guide plate and the lower surface of the first light guide plate.

11. The dual view display apparatus of claim 6, wherein the display panel displays different images to the viewer in the left or right direction through a liquid crystal display by reproducing the different images at a 90 HZ refresh rate or more.

12. The dual view display apparatus of claim 6, wherein an edge surface of the light guide plate is pattern treated to minimize crosstalk generated from light reflected back by the reflection surface.

13. The dual view display apparatus of claim 6, wherein the light refracted from the lens output layer heads toward the viewer in the right or left direction deviating by ±10° or more from the normal axis of the dual view display.

14. The dual view display apparatus of claim 6, wherein the prism input layer is provided with the plurality of prisms having the prism apex from 80° to 90°, and the prism pitch from 40 um to 60 um.

15. The dual view display apparatus of claim 6, wherein peak centers of the prism pitch of the prism input layer and the lens pitch of the lens output layer are misaligned so that crosstalk of the dual view display is decreased to a value equal to or lower than a predetermined value.

16. The dual view display apparatus of claim 15, wherein a peak-to-peak pitch value between the prism pitch of the prism input layer and the lens pitch of the lens output layer is misaligned within a range from 0 um to 20 um.
